(19) United States
(12) Patent Application Publication
(10) Pub. No.: US 2025/0276615 A1
(43) Pub. Date: Sep. 4, 2025

(54) DEVICE FOR ADJUSTING A SEAT, AND INSTALLATION ASSEMBLY FOR SUCH A DEVICE

(71) Applicant: Brose Fahrzeugteile SE & Co. Kommanditgesellschaft, Coburg, Coburg (DE)

(72) Inventors: Waldemar SCHRÖDER, Ahorn (DE); Johannes ULTSCH, Michelau i. OFr. (DE)

(21) Appl. No.: 18/862,640

(22) PCT Filed: Apr. 28, 2023
(86) PCT No.: PCT/EP2023/061226

§ 371 Date: Nov. 4, 2024

(30) Foreign Application Priority Data
May 2, 2022 (DE) 10 2022 204 333.2

(51) Int. Cl. B60N 2/02; B60N 2/23

(52) U.S. Cl. CPC B60N 2/0272; B60N 2/233

(57) ABSTRACT

A device adjusts a seat, which has a seat part and a backrest adjustable between two end positions including an upright position and a folded-over folding position, using an adjustment mechanism. The adjustment mechanism has opposing rotary fittings connected together via a shaft that extends along the shaft axis. The device is provided for detecting the two end positions. A spindle is connected to the shaft and a spindle nut is moved in the longitudinal direction in a translational manner when the shaft is rotated. The spindle nut is part of a driver which has an actuation element for a limit switch. The driver is guided in a forced manner by a mechanical slotted guide such that the translational movement is superimposed with a rotational movement of the driver, and the slotted guide is configured such that the actuation element actuates only one limit switch in the two end positions.

The invention relates to a device for adjusting a seat, in particular a vehicle seat, and an installation assembly for such a device.

The seat is, in particular, the seat in a vehicle, in particular of a second or third seat row. In particular, it is a foldable seat which has a seat part and a backrest which can be folded over relative to the seat part. The backrest is typically pivotable between two end positions, namely between an upright normal position, also denoted as the comfort position, and a folded-over folding position, also denoted as the loading floor position. In the folding position, the backrest is frequently oriented substantially horizontally. For adjusting the backrest, such seats regularly have an adjustment mechanism. The backrest is generally fastened in a pivotably movable manner via the adjustment mechanism. To this end, rotary fastening points are provided, said rotary fastening points being denoted herein-after as rotary fittings without limiting the generality.

Generally two opposing rotary fittings which are connected to one another via a shaft are provided. The shaft serves as a drive shaft and also for the synchronization of the adjusting movement of the two rotary fittings. This shaft defines a shaft axis which at the same time is generally a pivot axis. The shaft axis is frequently not fixed but itself performs a typically wobbling movement during the pivoting movement.

In the case of an electric motor-driven backrest adjustment, a system for identifying end positions is typically provided for protecting the drive motor in order to stop the drive motor in a timely manner and to protect it from overload.

Such a seat with an electrically adjustable backrest can be seen in DE 10 2004 061 960 A1, in which the end positions are identified by means of two limit switches. For actuating the two limit switches, a spindle with a spindle nut is attached to the shaft. The spindle nut has a radially protruding switching cam which can be moved in a translational manner between two end positions in order to actuate the two opposingly arranged limit switches.

Typically a head restraint, which is frequently configured as a foldable head restraint, is fastened to the backrest. This head restraint can be folded down from a normal operating position, in which it is located in a position for protecting an occupant, into a folded-over position. This folded-over position is generally adopted, in particular, in the folding position of the backrest. In the operating position, the head restraint is locked and secured by means of a releasable locking mechanism. Thus a release of the locking mechanism is required for folding over into the folded-over position.

In particular in automatic, electrically driven backrest adjustments, the adjustment mechanism is frequently complex and costly and requires a large amount of installation space in order to be able to fulfil these different functions.

Proceeding therefrom, the object of the invention is to permit a seat adjustment, in particular an electrically driven automatic backrest adjustment, with a small amount of effort and in a space-saving and cost-effective manner.

The object is achieved according to a first aspect of the invention by a device for adjusting a seat, in particular a foldable vehicle seat as described above, which has a seat part and a backrest that can be adjusted between two end positions, namely between an upright normal position and a folded-over folding position using an adjustment mechanism. The adjustment mechanism has, in particular, an electric drive motor for an automatic adjustment. Moreover, the adjustment mechanism has opposing rotary fittings, the backrest being pivotably movably fastened thereby, for example, to the seat part or to a holding structure. The rotary fittings are connected together via a shaft that can be rotated about a shaft axis and extends along the shaft axis in the longitudinal direction.

The device also has a device for detecting the two end positions, wherein this device has a spindle connected fixedly in terms of rotation to the shaft and a spindle nut which is moved in the longitudinal direction in a translational manner when the shaft is rotated. The spindle nut is part of a driver which has an actuation element for actuating a limit switch. The driver is guided in a forced manner by means of a mechanical slotted guide and namely such that the translational movement of the spindle nut and the thus of the driver is superimposed with a rotational movement. The slotted guide is designed such that the actuation element actuates the limit switch in the two end positions and namely, in particular, such that in each case a switching signal is generated when a respective end position is approached.

Actuating the limit switch is understood to mean that the actuation element exerts a movement relative to the limit switch so that it performs a mechanical adjusting movement and, in particular, is moved into a different switching state. To this end, the actuation element is either guided away from the limit switch or pushed toward the limit switch. The limit switch is preferably uninfluenced by the actuation element between the two end positions, i.e. is not actuated.

A particular advantage of this embodiment, in particular, can be seen to be in the requirement and provision of only a single limit switch which is thus actuated in each case when one of the two end positions is reached. The actuation element for actuating the limit switch is thus rotated relative to the limit switch due to the superimposed rotational movement, in order to actuate said limit switch thereby.

The object is achieved according to a second aspect of the invention by a device for adjusting a seat, which in turn can be adjusted by means of the adjustment mechanism between the two end positions. A head restraint is fastened to the backrest, said head restraint being able to be folded over from an operating position into a folded-over position, wherein the head restraint can be locked in the operating position by means of a releasable locking mechanism so that in the normal operating position the head restraint is locked, in particular, in a crash-safe manner. Preferably, when the locking mechanism is released, a folding over of the head restraint into the folded-over position is at least assisted or carried out by means of a spring mechanism or a motorized drive.

A driver is provided for releasing the locking mechanism in order to permit a folding over of the head restraint, said driver being connected to the shaft and performing a rotational movement about the shaft axis when the shaft is rotated. A control element which is, in particular, strand-shaped and preferably flexible is fastened to the driver, said control element being connected to the locking mechanism for the actuation thereof, in particular for the unlocking thereof, and namely such that when the backrest is adjusted an actuation, in particular an unlocking, of the locking mechanism takes place automatically via the control element. The control element is moved by the rotational movement of the driver, therefore, and thus exerts an adjusting stroke on the locking mechanism, whereby this locking mechanism is released. In particular, the control element exerts a pulling force on the locking mechanism, in particular on a locking element or bolt element, in order to actuate said locking element or bolt element.

The particular advantage of this embodiment can be seen to be that, when the backrest is adjusted, any rotation of the shaft which is present is used for the automatic actuation of the locking mechanism and thus enables the head restraint to be folded over. The actuation of the locking mechanism is thus forcibly coupled to the backrest adjustment in a simple manner.

For generating the rotational movement of the driver, the above-described spindle which is connected to the shaft is preferably provided, and the driver has the already mentioned spindle nut which is moved in the longitudinal direction in a translational manner when the shaft is rotated. Moreover, the driver is guided in a forced manner by means of the slotted guide for generating its rotational movement. The particular advantage achieved by the slotted guide is that the rotational movement and the required adjusting stroke is controlled in a targeted manner. Thus the slotted guide or even the slotted control causes the actuation of the locking mechanism at a defined pivoting position of the backrest relative to the seat part. In particular, an actuation of the locking mechanism takes place at the start of the pivoting movement of the backrest from the normal position in the direction of the folding position.

In a preferred embodiment, these two above-described aspects are combined with one another. Due to the specific design of the driver which performs a translational movement and a rotational movement via the rotational movement of the shaft, therefore, two different functions, namely on the one hand the actuation of the limit switch and on the other hand the actuation (unlocking) of the locking mechanism of the head restraint, are coordinated and performed by a common mechanism. This achieves a particularly compact embodiment with few components overall, which as a whole leads to a cost-effective solution.

The control element preferably has as a strand-shaped element, a cable, a wire or even a plastics strand and is also preferably designed as a Bowden cable. In particular, the control element is configured for transferring both pulling forces and pushing forces to the locking mechanism.

In a preferred embodiment, the slotted guide is generally configured such that during the translational movement of the driver in the longitudinal direction, i.e. in only one direction, the driver itself is actuated in different rotational directions. This results in a targeted control in and counter to a defined rotational direction about the shaft axis. As a result, a controlled rotational movement of the actuation element is achieved for actuating the limit switch in the first aspect of the invention and for generating a controlled and defined adjusting stroke in different directions in the second aspect of the invention. Thus, when the backrest is pivoted in only one direction, the slotted guide ensures that the actuation element and/or the control element itself perform different and, in particular opposing, movements. As a result, it is ensured that in the first aspect the actuation element can actuate only one limit switch, which is preferably configured as a button, in both end positions.

The slotted guide is configured, in particular, such that during the translational movement in the longitudinal direction, i.e. in only one direction, starting from the first end position of the backrest (normal position) in a starting region the driver rotates in a rotational direction, and that in the region of the second end position of the backrest (folding position) in an end region of the translational movement the driver rotates in the opposing direction to the rotational direction. The driver generally moves in the longitudinal direction along the spindle from a first end position, from the starting region to a second end position in the end region. The start and the end of the translational movement are defined by the two end positions of the backrest, to which the two end positions of the driver correlate.

In particular, in the starting region the limit switch, which preferably is configured as a button, is actuated for the first time by the rotational movement in the rotational direction via the actuation element. For actuating the limit switch, in particular, it is provided that the actuation element is rotated away from the limit switch and thus away from the button. This means that the button is transferred from a previously pushed-in position into a relieved, released position in which the actuation element is moved away. Conversely, the limit switch is actuated again by the actuation element in the end region by the opposing rotation. In particular, it is provided that the button is pushed in, i.e. that the actuation element is rotated toward the button and thereby a switching signal is generated, thus signaling that the (second) end position has been reached. This switching signal is detected by a suitable electronic controller and leads, in particular, to the stopping of an electric drive motor.

In the opposite process, i.e. when the backrest is folded up from the folding position into the upright position, the movement sequence of the driver is reversed.

In other words, the driver is moved in a translational manner counter to the longitudinal direction and rotates counter to the rotational direction so that in the end region it is firstly rotated away from the limit switch and in the starting region pushes the limit switch, and thereby generates a switching signal when the first end position is reached.

The movement sequences are described hereinafter, in each case starting from the upright normal position in the direction of the folded-over position. The entire adjustment mechanism is configured such that with the opposing movement, i.e. when folding up from the folding position into the normal position, the movement sequences are in opposing directions and take place in the reverse sequence.

With regard to the second aspect of the invention, in the starting region the control element is loaded and, in particular, tensioned by the rotational movement in the rotational direction so that the control element performs the control stroke for actuating the locking mechanism. In the end region, the control element in turn is relieved of load, i.e. is relaxed again, in particular, by the opposing rotational movement.

In a preferred development, during the translational adjustment a central region which is configured between the starting region and the end region is provided after the starting region. The limit switch is not actuated in this central region. The slotted guide is thus configured such that the functional state of the actuation element and/or the control element is maintained. The control element preferably remains in the central region in the tensioned state. The central region extends, for example, over at least 40% and preferably over at least 50% of an entire translational adjustment path of the driver along the spindle.

The length of the starting region in the longitudinal direction corresponds, for example, to a maximum of 30% and, in particular, a maximum of 20% of the length of the entire translational adjustment path. The length of the end region preferably also corresponds to a maximum of 30% and, in particular, a maximum of 20% of the length of the entire translational adjustment path. The length of the end region and the starting region are preferably identical.

This measure ensures that, at the start of the backrest adjustment from the normal position, a rapid actuation of the limit switch and, in particular, a rapid actuation of the control element is achieved for unlocking the locking mechanism, and that over the central region of the translational adjustment path of the driver and thus over the partial region of the adjustment movement of the backrest, the control element or the actuation element is held in a quasi neutral position in which there is no change to its state, in particular no triggering of a function, such as the actuation of the limit switch or the control element. In this central region the actuation element is held spaced apart from the limit switch. With regard to the second aspect, the control element is held in the loaded position, i.e. the tensioned position, in the central region.

In a preferred development, the slotted guide has portions with different gradients relative to the shaft axis, so that-depending on its translational position along the spindle-the driver has different rotational speeds and/or different rotational directions. Due to this measure, therefore, the movement sequences for the actuation element and/or the control element are set in a targeted manner and as required.

Expediently, the driver has a sleeve-shaped part with an internal thread for forming the spindle nut, wherein one or more and preferably all of the elements cited hereinafter are configured on the peripheral side on the sleeve-shaped part.

Thus a holder is preferably provided, in particular a nipple holder for an end piece, in particular for a nipple of the control element.

Alternatively or additionally, the actuation element is configured to be elongated in the longitudinal direction and preferably as a rib oriented in the longitudinal direction. The length of the actuation element in the longitudinal direction corresponds, in particular, at least to the translational adjustment path of the driver between its two end positions. As a result, it is reliably ensured that the actuation element actuates the (single) limit switch by the rotational movement in or counter to the rotational direction in both end positions.

As an alternative to an actuation element extending over such a length, this actuation element can also be composed of two sections which are spaced apart from one another in the longitudinal direction and which are positioned such that they are located in the respective end position at the longitudinal positions of the limit switch.

Moreover, a guide element which is configured, in particular, as a guide pin and which protrudes in the radial direction and positively engages in the slotted guide is arranged on the sleeve-shaped part.

The driver is preferably configured as a one-piece monolithic component and consists, for example, of plastics. The component is produced, for example, as a cast part, injection-molded part or by a 3D printing method.

In a preferred embodiment, a carrier component is also provided, said carrier component, in particular, being fixedly connected to the backrest and having the slotted guide and a bearing for the spindle. This carrier component is, in particular, a component of a complete installation assembly which can be fastened to the seat, in particular to the backrest.

The carrier component preferably has at least one and preferably a plurality and, in particular, all of the following elements: at least one and preferably a plurality of fastening elements for fastening the carrier component to the seat and, in particular, to the backrest. To this end, in particular, latching or plug elements are provided. Alternatively or additionally, for example, screw fastening elements are provided.

In particular, a guide for the control element is configured on the carrier component. This guide is, in particular, a channel which, for example, is open on one side and into which the control element, in particular the Bowden cable, can be inserted.

Preferably, the carrier component also has a mount for an electronic assembly, wherein the electronic assembly in turn comprises the limit switch. As a result, the position of the limit switch on the carrier component is defined and thus also in relation to the spindle and thus to the driver.

The carrier component is preferably a one-piece monolithic component, in particular made of plastics. The carrier component is produced, for example, as a cast part, injection-molded part or by a 3D printing method.

The object is further achieved according to the invention by an installation assembly for such a device as described above. This installation assembly has the above-described carrier component, the spindle and the driver. The slotted guide is integrated in the carrier component. Moreover, the spindle is rotatably mounted on the bearing, for example a plain bearing. The spindle is generally preferably hollow and configured for passing through the shaft and for connecting to the shaft fixedly in terms of rotation. The connection which is fixed in terms of rotation is configured, for example, by a frictional connection between the shaft and spindle. Preferably, a positive connection is configured between the shaft and spindle.

Moreover, the guide element is arranged on the driver for engaging in the slotted guide, and finally the actuation element for the limit switch and/or the holder for the end piece of the control element is arranged.

This installation assembly forms a premounted structural unit which merely has to be fastened to the seat and, in particular, to the backrest.

An exemplary embodiment of the invention is explained in more detail hereinafter with reference to the figures. In partially simplified views:

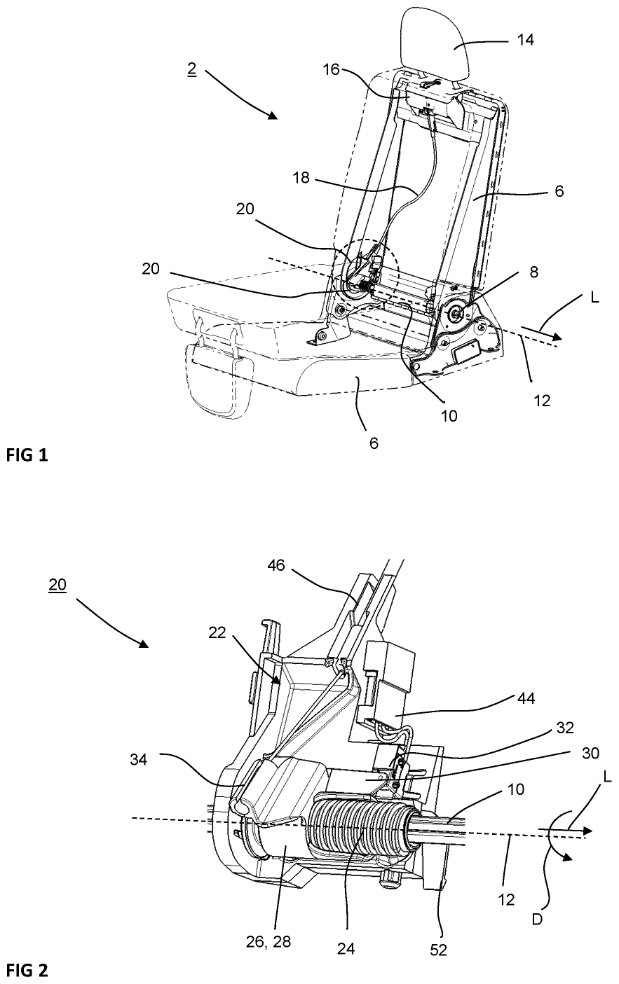

FIG. 1 shows a seat in a perspective view with a backrest in the up-right normal position and the backrest in a folding position in a view in dashed lines,

FIG. 2 shows a perspective view of an installation assembly with the carrier component, spindle and further elements,

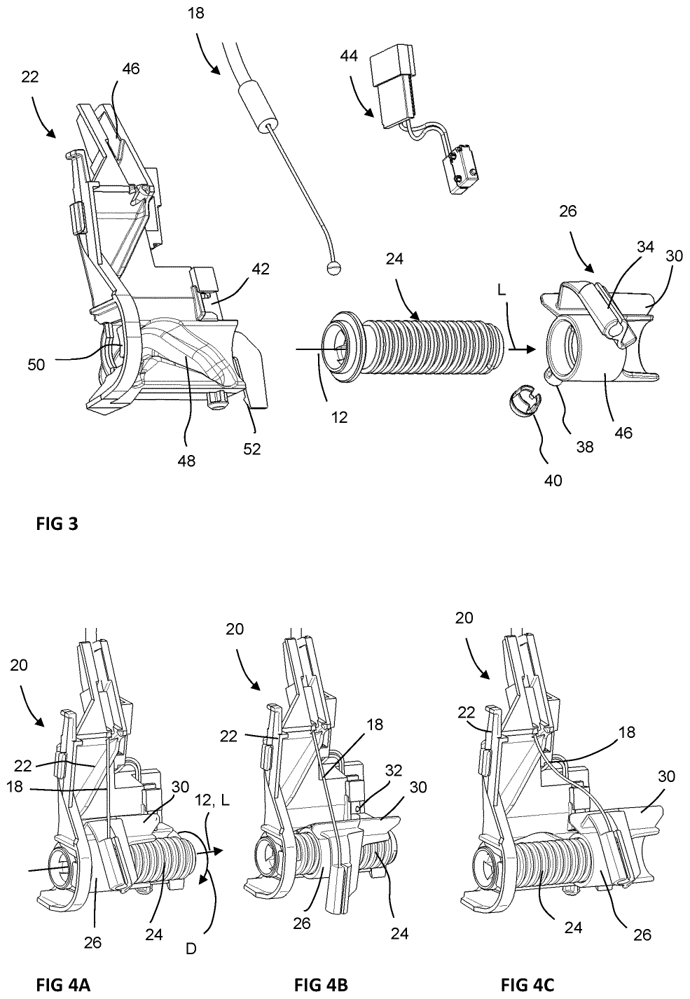

FIGS. 4A-4C show views of the installation assembly during operation in various positions, namely when the driver is in the starting region, in the central region and in the end region,

FIG. 3 shows an exploded view of the different elements of the installation assembly,

FIG. 5 shows a view of the installation assembly,

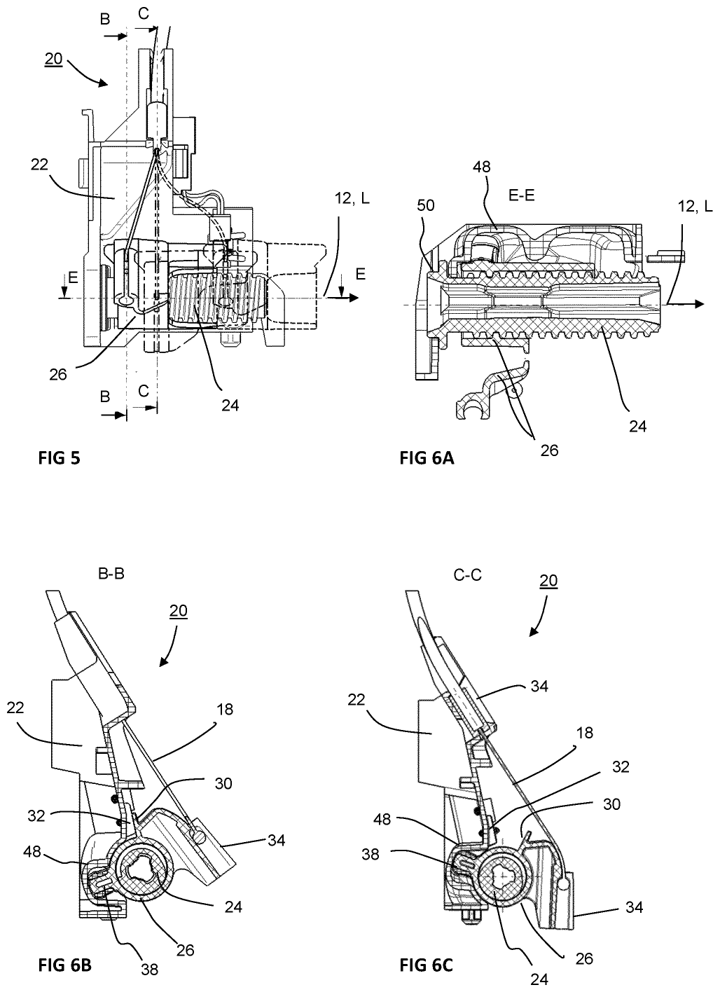

FIG. 6A shows a sectional view along the cutting line E-E in FIG. 5,

FIG. 6B shows a sectional view along the cutting line B-B in FIGS. 5 and

FIG. 6C shows a sectional view along the cutting line C-C in FIG. 5.

A seat 2 shown in FIG. 1 is provided as a vehicle seat for installation in a vehicle. The seat has a seat part 4 and a backrest 6 which can be pivoted and folded over relative to the seat part 4 from an upright normal position into a folded-over folding position. The seat part 4 and the backrest 6 located in the folding position are shown in dashed lines. Two opposing rotary fittings 8 are provided in order to permit the pivotability of the backrest 6, said rotary fittings being fastened in the exemplary embodiment to two opposing fastening structures, to which the seat part 4 is also fastened and via which a fastening to a vehicle floor takes place. The two rotary fittings 8 are connected together via a shaft 10 which extends along a shaft axis 12 in a longitudinal direction L. The shaft 10 is configured as a drive shaft for adjusting the inclination of the backrest 6 and is driven via an electric drive motor, not shown in more detail. The shaft 10 serves at the same time for the synchronization of the movement of the two opposing rotary fittings 8.

A foldable head restraint 14, which can be folded over from a normal operating position into a folded-over position, is also attached to the backrest 6. In the normal operating position, the head restraint 14 is oriented substantially in the direction of the backrest 6 (right-hand image half in FIG. 1 with the backrest 6 in the upright normal position) and in the folded-over position substantially transversely to the backrest 6 (left-hand image half, view in dashed lines of the backrest 6 and the heat restraint 14 in the folding position). The position of the head restraint 14 can be locked in the operating position by means of a locking mechanism 16. A control element 18, which is configured in the exemplary embodiment as a Bowden cable, is provided for releasing the lock of the locking mechanism 6. The head restraint 14 is generally pretensioned by means of a spring mechanism, so that when the lock is released the head restraint automatically folds over into the folded-over position due to the spring force.

The rotary fittings 8, the shaft 10, the locking mechanism 16, the control element 18 and the electric drive motor are parts of an adjustment mechanism for the electric motor-controlled adjustment of the backrest 6. The positions of the backrest 6 shown in FIG. 1, namely the upright normal position and the folded-over folding position, form end positions. The adjustment mechanism generally has a device for detecting these two end positions which in each case outputs a signal to the motor controller when the end positions are reached, so that the drive motor is stopped. When the backrest 6 is folded over, the lock of the locking mechanism 16 is also automatically released and the head restraint 14 folds over into the folded-over position.

The detection of the end positions and the parallel unlocking of the locking mechanism 16 take place by means of a specific mechanism, as is explained in more detail hereinafter. In particular, a premounted installation assembly 20 is provided to this end, said premounted installation assembly being identified in

FIG. 1 by the circle in dashed lines. It is preferably arranged immediately adjacent to one of the rotary fittings 8, in the exemplary embodiment to the rotary fitting 8 on the left-hand image half.

The construction and function of the installation assembly 20 is seen, in particular, in the following figures. FIG. 2 shows the mounted installation assembly 20 and the individual elements of the installation assembly 20 can be clearly identified by way of the exploded view according to FIG. 3.

As an alternative to a premounted installation assembly, the individual elements are arranged, for example, individually on a backrest structure. The following description of the cooperation of the individual elements applies equally to such a fastening and is independent of the embodiment of the premounted assembly.

As can be identified by way of FIG. 2 and FIG. 3, the installation assembly 20 has a carrier component 22 which, in particular, is configured as a monolithic component, for example as an injection-molded component. Moreover, the installation assembly 20 has a spindle 24 which is configured as a hollow cylindrical element. The shaft 10 is inserted through the spindle 24 and connected fixedly in terms of rotation thereto. To this end, in the exemplary embodiment the shaft 10 has a non-circular cross-sectional geometry and is configured as a polygon, for example, at least in the region of the spindle 24. Moreover, a driver 26 which is preferably also configured as a monolithic one-piece component, for example as an injection-molded part, is attached to the spindle 24.

The driver 26 has a sleeve-shaped part 28 which bears an internal thread, not shown here in more detail, which is in engagement with the external thread of the spindle 24 so that with a rotation of the shaft 10 and the rotation of the spindle 24 associated therewith, the driver 26 is moved in a translational manner in or counter to the longitudinal direction L. The sleeve-shaped part 28 forms in this regard a spindle nut. An actuation element 30 for actuating a limit switch 32 and a holder 34 are configured on the peripheral side of the sleeve-shaped part 28 for fastening an end piece of the control element 18. The actuation element 30 generally extends in the longitudinal direction L and, in particular, is configured in the manner of a radially protruding projection or a rib. The holder 34 in the exemplary embodiment has a slotted hollow channel which, in particular, is configured as a so-called nipple holder chamber. A nipple, which is attached on the end side to a cable of the control element 18 configured as a Bowden cable (see also FIG. 3), is positively inserted therein.

A guide element which is configured as a guide pin 38 which protrudes in the radial direction is also arranged on the sleeve-shaped part 28 on the peripheral side. A cap 40 which is configured in the manner of a so-called roller cap is attached thereto in order to ensure as little friction as possible during operation (FIG. 3).

The carrier component 22 also has a mount 42 (FIG. 3) which receives an electronic assembly 44 which comprises the limit switch 32 already mentioned above. The electronic assembly 44 in the present case is substantially the limit switch 32 and a plug attached thereto. The limit switch 32 is connected to a control unit via an electrical plug connection. The limit switch 32 is configured as a button.

The carrier component 22 also has a guide 46 which is configured in the manner of a guide channel, in particular in an upper end region, in which the control element 18 is, in particular, positively received and held. As already mentioned above, the control element 18 is configured, in particular, as a Bowden cable which generally has a cable or a wire which is guided inside a tubular sleeve. On the end side the nipple is typically attached to the cable (see to this end in particular FIG. 3). Preferably an end piece of the sleeve is now positively held in the guide 26.

A slotted guide 48 is also configured inside the carrier component as an essential element, preferably as a channel-like recess inside the carrier component 22 and having a defined two-dimensional path (FIG. 3).

Moreover, the carrier component 22 has a bearing 50 which is configured, in particular, in the manner of a plain bearing and in which an end piece of the sleeve-shaped spindle 24 is rotatably mounted (FIG. 3). The bearing 50 and the end piece of the spindle 24 generally preferably serve both for the radial and for the axial fixing of the spindle 24 to the carrier component 22. To this end, the end piece initially has a sleeve-shaped projection which engages in the bearing 20 for the radial mounting. In addition, a rib-like peripheral and radially protruding projection is configured, said projection being provided for the axial fixing and bearing against a corresponding annular wall of the carrier component 22.

Fastening elements which are preferably configured as latching elements 52 are also configured on the carrier component 22. The carrier component 22 and thus the entire installation assembly 20 are fastened to the backrest 6 via these fastening elements.

The guide pin 38 engages in the slotted guide 48. With a rotation of the spindle and thus of the shaft 10, this leads to a translational movement of the driver 26 in or counter to the longitudinal direction L. Due to the engagement of the guide pin 38, this guide pin and thus the driver 26 are forcibly subjected to a rotational movement about the shaft axis 12 by the slotted guide 48. The translational movement of the driver 26 is thus superimposed with a rotational movement which is defined and controlled by the slotted guide 48.

The movement sequence is seen with reference, in particular, to the views of FIG. 4A to FIG. 4C:

In FIG. 4A the driver 26 is in a first end position which corresponds to the first end positions and thus the upright normal position of the backrest 6.

When the backrest 6 is adjusted in the direction of the seat part 6, the spindle 24 rotates and this leads to the translational movement of the driver 26 in the longitudinal direction L. Starting from a starting region (FIG. 4A) the driver 26 passes through a central region (FIG. 4B) and finally passes to an end region and reaches a second end position (FIG. 4C). This second end position corresponds to the second end position of the backrest 6 when it is in the folding position.

As can also be identified particularly clearly by way of FIG. 3, in particular, the slotted guide 48 is configured in the starting region to rise relatively steeply relative to the shaft axis 12 so that in the starting region the driver 26 has a high rotational speed and is rotated over a relatively large angular range in a rotational direction D. The end of the starting region is defined by the maximum rotational deflection in the rotational direction D.

Due to this rotational movement, firstly the actuation element 30 is lifted away from the limit switch 32, whereby this limit switch is partially released, as can be identified clearly by way of FIG. 4B, which shows the end of the starting region and the start of the central region.

At the same time, due to this rotational movement the control element 18 is tensioned and tightened by a defined adjusting stroke which leads to the unlocking of the locking mechanism 16.

In the following central region, the functional positions of the actuation element 30 and the control element 18 are at least substantially maintained. This means that the actuation element 30 also remains in its position lifted away from the limit switch 32, and the control element 18 in its tensioned position.

In the exemplary embodiment, an opposing rotation already takes place in the central region counter to the rotational direction but at a lower rotational speed (at a constant rotational speed of the shaft 10) so that the driver 26 is already gradually returned again from its maximum rotation in the rotational direction D as shown in FIG. 4B. The lower rotational speed-in comparison with the path in the starting region-is achieved by a flat, less steep and opposing path of the slotted guide 48 relative to the shaft axis 12.

In the case of the slotted guide 48, this is expressed, in particular, in that when viewed in the longitudinal direction L the slotted guide initially rises steeply up to a maximum lateral deflection transversely to the longitudinal direction L, in order to drop back again with a smaller gradient thereafter.

In the end region, finally the driver 26 is rotated back again substantially into the rotational position which it adopted at the start, i.e. in the first end position. As a result, the actuation element 30 is rotated again toward the limit switch 32 and actuates it, which is evaluated by the control unit as a switching signal for reaching the second end position.

In the second end position, the control element 18 is also relieved of load, i.e. tensile stress is no longer present.

When the backrest 6 is adjusted from the folding position into the upright normal position, the movement sequence is in the opposing direction, i.e. the driver 26 starts from its second end position in FIG. 4C and moves in the direction of its first end position in FIG. 4A. Moreover, with this movement the actuation element 30 is initially lifted away from the limit switch 32, then passes through the central region in this lifted-away rotational position, in order to be rotated again in the starting region in the direction of the limit switch 32 and to actuate it. As a result, when the first end position is reached, and thus the first end position (upright normal position), a switching signal is generated for stopping the electric motor.

The cooperation of the different components in the adjusting movement can also be identified, in particular, by way of the sectional views according to FIG. 6A to FIG. 6C. FIG. 6B shows a sectional view in the first end position, i.e. at the start of the adjusting movement and at the start of the rotational movement from the first end position. FIG. 6C shows a sectional view with the maximum rotational deflection of the driver 26, and thus this sectional view according to FIG. 6 defines the end of the starting region. It can be clearly identified by way of FIG. 6C how the limit switch 32 (button) is released by the actuation element 30 and that also the control element 18 is tightened by an adjusting stroke.

### LIST OF REFERENCE SIGNS

2 Seat
4 Seat part
6 Backrest
8 Rotary fittings
10 Shaft
12 Shaft axis
14 Head restraint
16 Locking mechanism
18 Control element
20 Installation assembly
22 Carrier component
24 Spindle
26 Driver
28 Sleeve-shaped part
30 Actuation element
32 Limit switch
34 Holder for control element
38 Guide pin
40 Cap
42 Mount for electronic assembly
44 Electronic assembly
46 Guide
48 Slotted guide
50 Bearing
52 Fastening element
L Longitudinal direction
D Rotational direction

1-14. (canceled)

15. A device for adjusting a seat having a seat part and a backrest being adjusted between two end positions, namely between an upright position and a folded-over folding position, the device comprising:
a shaft;
an adjustment mechanism having opposing rotary fittings connected together via said shaft being rotatable about a shaft axis and extending along a shaft axis in a longitudinal direction;
a limit switch;
an apparatus for detecting the two end positions, said apparatus having a spindle connected to said shaft and a spindle nut being moved in the longitudinal direction in a translational manner when said shaft is rotated, wherein said spindle nut is part of a driver which has an actuation element for said limit switch; and
a mechanical slotted guide, said driver being guided in a forced manner by means of said mechanical slotted guide such that a translational movement is superimposed with a rotational movement of said driver and said mechanical slotted guide is configured such that said actuation element actuates said limit switch in the two end positions.

16. The device according to claim 15, wherein said mechanical slotted guide is configured such that during the translational movement of said driver in the longitudinal direction said driver is actuated in different rotational directions.

17. The device according to claim 15, wherein said mechanical slotted guide is configured such that during a course of the translational movement in the longitudinal direction in a starting region said driver rotates in a rotational direction and in an end region the driver rotates in an opposing direction to the rotational direction, such that in the starting region said actuation element actuates said limit switch by the rotational movement in the rotational direction and, said actuation element is lifted away from said limit switch and that in the end region said actuation element actuates said limit switch again by the rotational movement in the opposing direction to the rotational direction.

18. The device according to claim 17, wherein a central region is configured between the starting region and the end region, wherein said limit switch is not actuated in said central region.

19. The device according to claim 15, wherein said mechanical slotted guide has portions with different gradients so that, depending on a translational position of said driver along said spindle, said driver has different rotational speeds and/or different rotational directions.

20. The device according to claim 15, wherein said driver has a sleeve-shaped part with an internal thread for forming said spindle nut and that at least one of the following elements is configured on a peripheral side on said sleeve-shaped part:
a holder for an end piece of a control element;
said actuation element is configured as a rib oriented in the longitudinal direction or has two sections which are spaced apart from one another in the longitudinal direction; and
a guide element which engages in said mechanical slotted guide.

21. The device according to claim 15, wherein said driver is configured as a monolithic, one-piece component.

22. The device according to claim 15, further comprising a carrier component, said carrier component having said mechanical slotted guide and a bearing for said spindle.

23. The device according to claim 22, wherein said carrier component also has at least one of the following elements:
at least one fastening element for fastening said carrier component to the backrest;
a guide for a control element; and
a mount for an electronic assembly which contains said limit switch.

24. The device according to claim 22, wherein said carrier component is a one-piece, monolithic component.

25. An installation assembly for a device, the installation assembly comprising:
a carrier component having a slotted guide and a bearing;
a driver forming a spindle nut;
a spindle rotatably mounted on said bearing of said carrier component and configured for passing through a shaft and for connecting to the shaft fixedly in terms of rotation;
a guide element disposed on said driver for engaging in said slotted guide; and
an actuation element for a limit switch and/or a holder for an end piece of a control element.

26. A device for adjusting a seat, the seat having a seat part and a backrest being adjusted between two end positions, namely between an upright position and a folded-over folding position, the device comprising:
a shaft;
a releasable locking mechanism;
an adjustment mechanism having opposing rotary fittings connected together via said shaft being rotated about a shaft axis and extending along a shaft axis in a longitudinal direction, wherein a head restraint is fastened to the backrest, the head restraint being able to be folded over from an operating position into a folded-over position and being able to be locked in the operating position by means of said releasable locking mechanism;
a driver being connected to said shaft and performing a rotational movement about the shaft axis when said shaft is rotated; and
a control element fastened to said driver, said control element connected to said releasable locking mechanism for an actuation of said releasable locking mechanism, such that when the backrest is adjusted an actuation of said releasable locking mechanism takes place automatically via said control element.

27. The device according to claim 26,
further comprising a spindle connected to said shaft;
wherein said driver has a spindle nut which is moved in the longitudinal direction in a translational manner when said shaft is rotated; and
further comprising a slotted guide, said driver is guided in a forced manner by means of said slotted guide for generating a rotational movement.

28. The device according to claim 26, wherein said control element has a cable or a wire.

29. The device according to claim 26, wherein said slotted guide is configured such that during a translational movement of said driver in the longitudinal direction said driver is actuated in different rotational directions.

30. The device according to claim 26, wherein said slotted guide is configured such that during a course of a translational movement in the longitudinal direction in a starting region said driver rotates in a rotational direction and in an end region the driver rotates in an opposing direction to the rotational direction, such that in the starting region said control element is loaded and, in particular, tensioned by the rotational movement in the rotational direction and a control stroke is performed for actuating said releasable locking mechanism and that in the end region said control element is relieved of load by the rotational movement in the opposing direction to the rotational direction.

31. The device according to claim 27, wherein said slotted guide has portions with different gradients so that, depending on a translational position of said driver along said spindle, said driver has different rotational speeds and/or different rotational directions.

32. The device according to claim 27, wherein said driver has a sleeve-shaped part with an internal thread for forming said spindle nut and that at least one of the following elements is configured on a peripheral side on said sleeve-shaped part;
a holder for an end piece of said control element;
an actuation element configured as a rib oriented in the longitudinal direction or has two sections which are spaced apart from one another in the longitudinal direction; and
a guide element which engages in said slotted guide.

33. The device according to claim 26, wherein said driver is configured as a monolithic, one-piece component.

34. The device according to claim 27, further comprising a carrier component having said slotted guide and a bearing for said spindle.

35. The device according to claim 34, wherein said carrier component further has at least one of the following elements:
at least one fastening element for fastening said carrier component to the backrest;
a guide for said control element;
a mount for an electronic assembly having a limit switch.

36. The device according to claim 34, wherein said carrier component is a one-piece, monolithic component.
